(19) United States
(12) Patent Application Publication
(10) Pub. No.: US 2004/0246096 A1
(43) Pub. Date: Dec. 9, 2004

(54) Secure electronic compartment lock and method therfor

(76) Inventor: Joseph A. Queenan, Trumbull, CT (US)

Correspondence Address: Joseph A. Queenan, 11 Stoneleigh Road, Trumbull, CT, 06611-3316, US

(21) Appl. No.: 10/454,909

(22) Filed: Jun. 5, 2003

(51) Int. Cl. H04Q 1/00; G05B 19/00

(52) U.S. Cl. 340/5.61; 340/5.73

(57) ABSTRACT

An electronic lock that can be used on luggage, baggage, rail cars, trailers or any compartment that can be opened and re-locked. The lock provides tracking of when the lock was opened, where the lock was opened and data relating to the key that was used to open the lock. An input facility on the lock receives programmed data, which is capable of engaging the lock. The programmed data is typically stored on a magnetic card. A detection facility is coupled to the latch mechanism of the lock, and the detection facility detects engagement of the latch mechanism by the card. A memory stores data relating to the programmed data that engaged the latch mechanism. An identifier is mounted in proximity to the latch mechanism that identifies the lock and an output facility outputs data representative of lock activity.

### TECHNICAL FIELD

This invention relates generally to a lock mechanism. More particularly, this invention relates to a lock mechanism that tracks the opening and closing of the lock and accumulates data related to lock activity.

### BACKGROUND

Currently, there is a growing concern about the ability for people to illegally transport, toxic, dangerous, explosive or hazardous material either overland, for example, by tractor-trailer or railroad, or on commercial airplanes. This concern is exacerbated by the fact that the ability for authorized personnel to reliably check for such materials, and to maintain records, is limited.

In order to minimize the risk of airline passengers or others transporting such materials on airplanes, the Transportation Safety Administration (TSA), which is a federal agency, screens baggage at all commercial airports in the United States, in an attempt to provide security to airlines and passengers. This screening process typically involves searching luggage and bags that are carried by passengers and “checked” (i.e., placed in a cargo compartment of the aircraft). In order to facilitate this screening process for checked luggage and bags, the TSA suggests that travelers keep their bags unlocked, if the bag is unlocked, the TSA will open and screen the bag. If the bag is locked, locks will be broken and removed. TSA officials will, typically, then secure bags and luggage with a plastic strip and will attempt to leave a note indicating that the bag was screened.

The above-described process gives rise to a host of problems. One problem is that, in instances in which bags are not locked, the bags are not secure, which enables unauthorized people to have access to a bag. Secondly, the present process lacks accountability of the screener. Thus, a screener could, either on purpose or inadvertently, remove contents of the luggage or bag during the screening process and there is no accountability to determine which individual (either a screener or other person) had access to the bag and may have removed the contents.

Furthermore, once the plastic tie has been placed on the bag, it may be difficult for the traveler to remove the plastic tie upon reaching their final destination. The plastic ties cannot be reused once they are removed from a bag.

Conventional locks and latching mechanism are not adequate to solve the above-described problems. For example, one conventional approach is disclosed in U.S. Pat. No. 6,472,973, entitled, “Information Collection And Disseminator For A Realty Lock Box” issued to Harold et al., that discloses an information collector and disseminator for a realty lock box in which a wireless radio link is added to a real estate lock box to transfer data obtained from the access key pad to a nearby receiver, which sends the data to a central site computer and compiles the data for dissemination. The lock box can also be controlled from a central site via a radio link. While such a lock is useful in the real estate context, this type of lock does not fulfill the needs for a compartment or luggage lock.

Another conventional lock is disclosed in U.S. Pat. No. 4,851,652, issued to Imran, entitled, “Electronic Lock Box, Access Card, System And Method.” This patent discloses a lock box in a secure entry system for use with a source of DC power having high frequency pulse width modulation thereon including a housing and a key container mounted in the housing movable between accessible and inaccessible positions. Circuitry is provided within the housing for controlling the movement of the key container and is adapted to be connected to the source of DC power. The circuitry is capable of receiving the high frequency pulse width modulated DC power. A capacitor serves to supply at least some of the power required by the circuitry during the time the pulse width modulation is occurring on the DC power supplied. While this patent solves the problem of preventing access to the lock by blunt force, such as a hammer blow, it does not adequately solve the problem of tracking the opening and closing of a lock.

Therefore, what is needed is a system that provides controlled/restricted access and accountability into the screening process of luggage or other compartments.

### SUMMARY OF THE INVENTION

Thus, in order to overcome the drawbacks and limitations of conventional locking mechanisms, particularly locks for luggage, baggage, railcars, trailers and the like, one embodiment of the present invention is directed to an apparatus that includes a latch mechanism that moves between an engaged position and a disengaged position. An input facility receives programmed data, which is capable of engaging the latch mechanism. A detection facility is coupled to the latch mechanism, and the detection facility detects engagement of the latch mechanism. A memory stores data relating to the programmed data that engaged the latch mechanism and an identifier is mounted in proximity to the latch mechanism that identifies the apparatus. An output facility outputs data representative of latch mechanism activity.

Another embodiment of the invention is one in which the apparatus as described above includes a retrieving mechanism that obtains data from the identifier and transmits the data to a storage facility.

Yet another embodiment of the present invention relates to a method for enabling engagement of a lock. The method includes providing programmed data to a latch and detecting engagement of the latch. Data is stored that relates to the programmed data capable of engaging the latch. The lock may be identified using a coded data representation. Data relating to engagement of the latch can then be output or transmitted.

Yet another embodiment of the present invention is directed to a system that includes a lock and a latch mechanism, mounted on the lock. An input facility receives programmed data, the programmed data is capable of engaging the latch mechanism. A detection facility is coupled to the latch mechanism, and detects engagement of the latch mechanism. A memory facility stores data relating to activity of the latch mechanism and an identifier is mounted in proximity to the latch mechanism and provides identification data. An output facility outputs data representative of latch mechanism activity.

Yet another embodiment of the present invention relates to an apparatus that includes a database that stores data relating to activity of a lock mechanism. An input/output module inputs data relating to a particular lock mechanism, the input data relates to times at which the lock mechanism was engaged, locations at which the lock mechanism was engaged and identities of keys that were used to engage the lock mechanism.

Yet another embodiment is directed to a system for tracking a plurality of articles. The system includes one or more locking mechanisms, each locking mechanism affixed to an associated article, and each locking mechanism having a detection facility adapted to detect engagement of the locking mechanism. One or more engagement devices, each engagement device adapted to engage the locking mechanisms. A storage facility adapted to store data relating to the engagement of the locking mechanisms. An output facility adapted to output data relating to the engagement of the locking mechanisms.

### BRIEF DESCRIPTION OF THE DRAWINGS

FIG. 1 shows a perspective view of a piece of luggage that includes a lock according to the present invention.

FIG. 2 shows a schematic diagram of an apparatus that includes the lock system according to the present invention.

FIG. 3 shows a flowchart of steps that can be used to implement the present invention.

### DETAILED DESCRIPTION OF THE INVENTION

The above-mentioned drawbacks and disadvantages are overcome by the present invention. The present invention provides a secure, efficient and accountable screening process and system that uses an accountable secure lock.

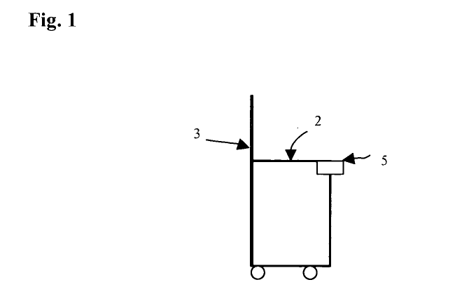

FIG. 1 shows a perspective view of a piece of luggage 2. The luggage 2 has handle 3 and a lock 5. The lock 5 is a portable electronic lock that ensures only those authorized can open the luggage. Authorized persons may include, for example, the owner of the luggage and/or a baggage screener. The lock 5 may have essentially any dimensions, and the dimensions are not critical to the understanding of the invention. One possible lock may have dimensions of approximately 6 inches by 4 inches and integrates an electronic radio frequency identification (RFID) lock and key system that enables tracking and monitoring the opening and closing of the lock. The lock 5 may be accessed or engaged by one or more user keys, which have dimensions of approximately a credit card. (User keys not shown in FIG. 1.) Universal master keys, or engagement devices, are keys or devices that have a memory portion thereon. (Master keys not shown in FIG. 1.) The master keys are assigned to a baggage screener to enable the screener to open the luggage. The master keys can be recharged and reassigned.

While FIG. 1 shows the lock 5 mounted on a piece of luggage 2, the lock 5 may also be mounted on a larger compartment, such as a rail car, trailer, automobile, or other storage device. The lock 5 may also be mounted on other objects as well, for example, a laptop computer, jewelry case, rental locker, boat rack or other compartment or area.

The lock 5 may be mounted on the luggage or may be removable, based on the needs of the user. The lock 5 may be attached to a cable, which enables the lock to be affixed to various compartments. The cable secures the lock to a bag, piece of luggage, rail car, trailer, or other compartment.

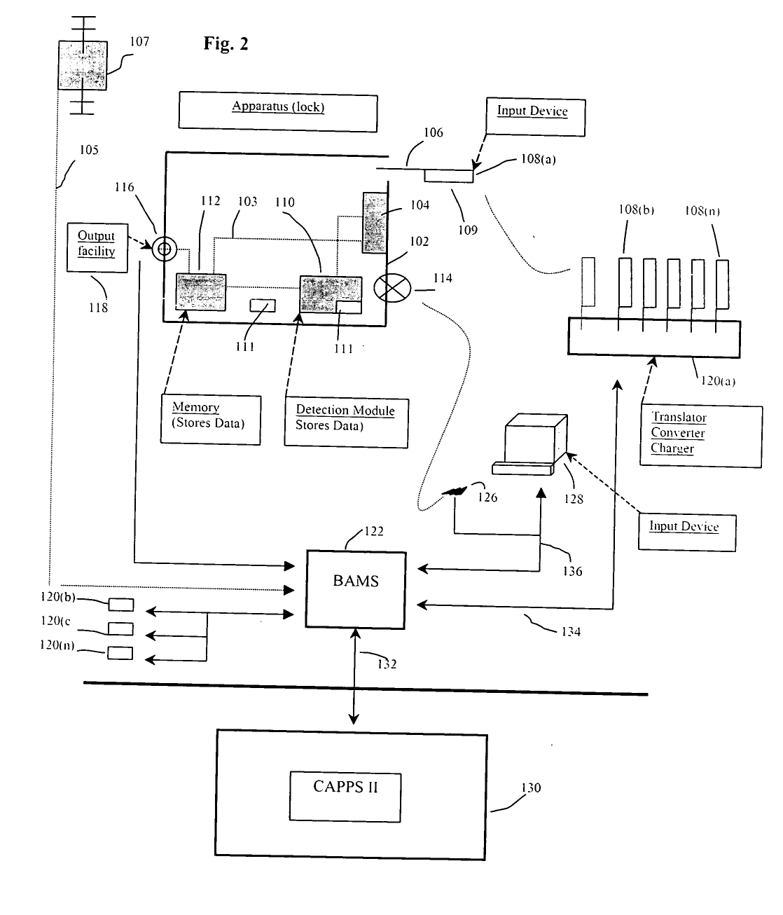

FIG. 2 shows a schematic diagram 10 of an apparatus that includes the lock 102 of the present invention and various databases and input terminals. The apparatus enables the activation of the lock 102 to be tracked and the lock to be traced.

The lock 102, is typically mounted on a piece of luggage, bag or other compartment or container, as described herein. These containers may be for example, railroad cars, trailers, safes, laptop computers, lockers, jewelry cases or other containment devices. The lock 102 includes a latch mechanism 104 that restricts, limits or controls access to the contents of the bag. Although essentially any latching mechanism capable of being engaged to open is suitable, one example is a mechanism that includes a bolt, a catch and a handle, such that the bolt moves from a locked position to an unlocked position when the catch is moved by means of the handle from a latched position to an unlatched position. Information is stored when the bolt is moved from the locked position to the unlocked position.

Input devices, or engagement devices, or keys, or opening devices 108(a) . . . (n), where n is any suitable number, are, for example, magnetically coded plastic cards, or smart cards, or contact tokens, or non-contact tokens or cryptographic tokens or memory cards that may be inserted into, or placed in proximity to, input port, or input mechanism, or input facility 106, so as to interface with the facility 106. Alternatively, a wireless engagement signal, which engages the latch 104, may be transmitted to the input facility 106. These access devices, or signals, generally, 108 may be issued or assigned to the owner/user of the lock or to authorized screening personnel to examine the contents of a bag. One embodiment of the present invention is that biometric information is encoded on the access cards 108. The biometric information may be, for example, fingerprint data, facial data or similar personal information that is stored on the access facility to facilitate verification of the user.

Each input device, or engagement device, or key, or opening device, or card, generally 108 includes an associated battery 109 and authorization data stored in a storage medium on the card 108. The input cards, or access devices, 108 are also referred to herein as universal cards, or master cards, or screener cards and may be issued to authorized personnel for examining or screening the contents of the luggage or compartment.

In an embodiment in which the compartment is a piece of luggage, the screeners may be airport security personnel who are issued a master card 108 to enable them to examine the contents of a passenger's bag or piece of luggage. In order for the screener to be authorized to open the luggage, the master or universal card must be programmed with authorization data. This authorization data may be programmed to enable only limited access, for example, the screener may only be able to open a specified number of bags or be able to open bags only during a specified time (i.e., a shift). The authorization data may be coded, for example with a bar code, or encrypted, or a combination of encoding and encryption.

The latch 104 is operatively coupled to detection module 110, which detects movement across the latch 104. This movement is typically engagement of the latch 104. The detection module 110 may be for example a radio frequency identification element or device, an infrared (IR) element or device, OCR (optical character recognition) device or other sensor that is adapted to detect when the latch 104 has been engaged by an authorized card or device 108.

The detection module 110 is operatively coupled to local memory 112. Local memory 112 stores data relating to detected latch activity. This data includes the time and location the lock was engaged, the card that engaged the lock and other information that may be gathered while the lock is being opened and closed. Memory 112 is coupled to latch 104 via interconnector 103. Battery module 111 provides power to the detection module 110 and the memory 112.

The memory 112 may be located within the lock 102 or outside the lock 102. Alternatively, the detection module may transmit data directly to central database 122 and obviate memory 112.

The memory 112 is also coupled to output facility, or module 116, which is for example a universal serial bus (USB), or a port that can transmit data to a storage medium such as a magnetic card, or storage card or smart card 118. Alternatively, the output facility 116 may output data, via a hard-wired or wireless connection 138 data to central database 122.

Identifier 114, which is for example, a coded representation of identifying information relating to the lock 102 or bag to which the lock 102 is affixed, stores data that correlates the lock 102 or bag to a particular user. Additional information may be associated with the identifier 114 as the bag is inspected.

Global positioning satellite (GPS) 107 is suited to receive data from identifier 114 and transmit the data to central database 122, via wireless connection 105. This information may be tracking information to track the location of the lock 102. This is particularly useful if a bag, or other compartment, with the lock 102 is lost or misdirected. Furthermore, if a traveler has a plurality of bags, it is possible to track the whereabouts of each bag.

When a bag is screened, or examined, a card, or other input device, 108, as described herein, is inserted into, or engages, input facility 106. If the key, or card, 108(a) is valid, the latch 104 will move into an open state and enable access to the contents of the compartment.

Upon completion of a shift, the authorized person may replace the card or other input device, or master key 108 into a converter device, or translation device, 120(a). The data from the input device 108 may be uploaded, or transmitted to either a database or other electronic storage medium. Alternatively, the data may be transmitted from the device 108 and then transmitted via a wireless network to a remote location. The converter device 120(a) typically has a reader unit that receives data from a plurality of master keys 108(a) . . . (n). This enables the converter 120(a) to gather and store data from each of the master keys 108(a) . . . (n). This data may be for example, identifier data, which identifies each bag locked/unlocked, the time each bag was lock/unlocked and the time each bag was locked/unlocked. Data from the converter 120(a) may be provided to central database 122 via bi-directional communication link 134. This link 134 may be a telephone line, wireless connection or other data transmission medium.

Input module 128, enables an operator to input additional data to a central database 122. Input module 128 is, for example, a stand-alone computer such as a personal computer (PC) (e.g., a computer with Intel™ Pentium™ 4 processors at 2.0 GHz and 256 MB of memory), laptop computer, personal digital assistant (PDA) or other electronic device capable of storing and transmitting data. The input module 128 typically includes a mouse and/or keyboard to enable an operator to input additional data about a particular bag or compartment. For example, if an operator desires to make notes about the contents of a bag or piece of luggage, the operator can either key in the data, such as an alert, or may use soft keys or pre-programmed indicators indicating that the bag contains suspicious articles or other contraband. Input module 128 may also be coupled to a scanner 126 or other peripheral device, which can also input data into central database 122, via bi-directional communication link 136. Bi-directional communication link 136 may be similar to link 134 described above.

Central database 122 may be operatively coupled to a plurality of converter devices 120(a) . . . (n), where n is any suitable number, via a bi-directional communication link. The central database 122 may also be operatively coupled to a plurality of input devices, shown herein as 128 to receive additional data. The central database 122 is adapted to process this information and provide data to other converter devices and other input devices. For example, if the contents of a bag are examined and found to contain suspicious articles or materials, an operator can input information into central database 122 either by scanner 126 or input device 128. The additional data is associated with the lock by associating the additional information with the identifier 114 at central database 122. Thus, at a subsequent location, an alert flag can be triggered, or other notice provided, when the bag is subsequently checked. This is accomplished by triggering an alert signal when the identifier tag 114 is scanned or by downloading the data to keys 108 at other locations so that when authorized personnel open the lock the key 108 provides an alarm or other indication that the lock and/or associated contents of the container have been previously identified as a heightened security risk.

As shown in FIG. 2, a plurality of converter units 120 may be used. For example, each airport or screening location may have a converter 120 that receives data from keys at that location. For example, Newark airport may have one or more converter device(s), shown as 120(a) and Denver airport may have one or more converter device(s), shown as 120(b). Each device 120(a) and (b) may be adapted to transmit data to a central database 122. This transmission means is shown as interconnector 134, which couples converter device 120(a) to central database 122. Interconnector 134 is for example a wireless or telephone line connection, wide area network (WAN) connection, local area network (LAN) connection. The central database 122 may also receive additional data from input module, or device, 128, via interconnector 136. Interconnector 136 is, for example a wireless or telephone line connection, wide area network (WAN) connection, local area network (LAN) connection. The central database 122 can transmit information received from converters 120 and input devices 128, 126 to other converters and input devices. Thus a person scanning bags in Denver will have access to the results of the scanning process that occurred in Newark.

Central database 122 may also be operatively coupled to a second database 130, via bi-directional interconnector 132, which may be for example CAPPSII, a government sponsored database, thereby further disseminating the information gathered by central database 122.

Although the above description is described in terms of a lock on a piece of luggage, the present invention also applies to securing railcars, storage containers, trailers, food containers, medicine containers, radio active material containers, safes, laptop computers or other compartments.

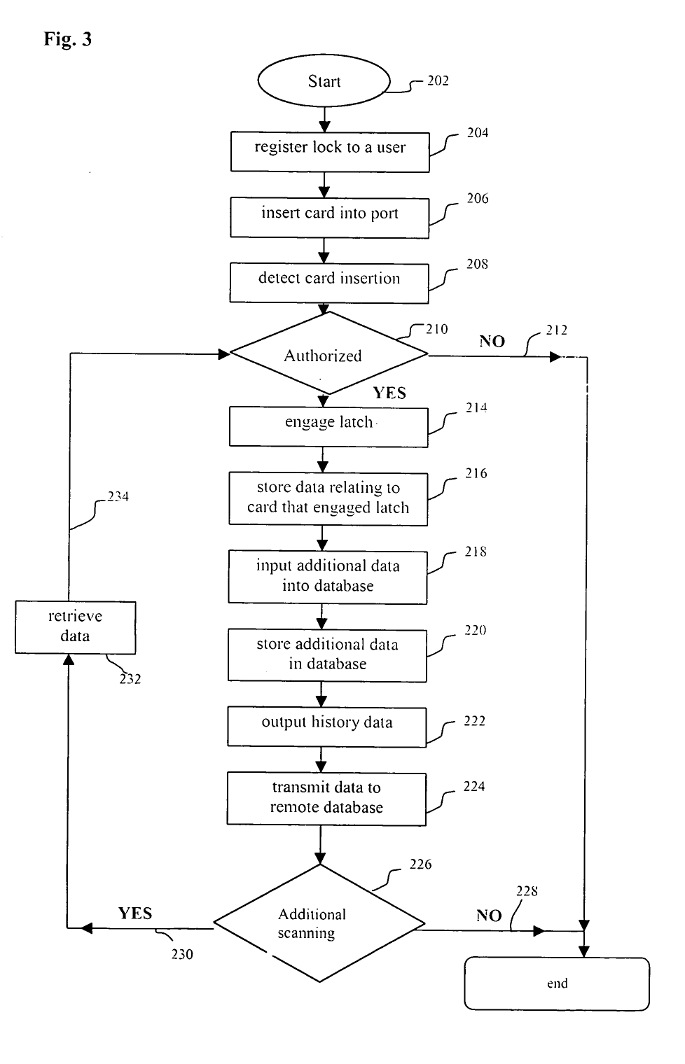

FIG. 3 shows a flowchart 20 of a series of steps that can be used to implement the present invention. Start block 202 begins the process. Block 204 shows that a lock is registered, or otherwise associated with, to a user. This registration may be performed on-line, via a website or over the telephone. In order to verify a user, the user must provide some verifiable form of identification, which may be encoded on a master key on a magnetic strip.

Block 206 shows that an access card, or device, or wireless signal, which may be operated by either an individual, such as the owner or assignee of, the lock or authorized personnel that will be examining the contents of a compartment, is inserted into, or transmitted to, a port on the lock. The access card, or device may be for example a smart card, cryptographic token, contact token or non-contact token, or wireless signal, or other medium. The lock then detects that an authorized request has been made to engage the lock and decision block 210 determines whether the input is authorized to engage the latch. If the input is not authorized, “NO” line 212 leads to end block 236. If the input is authorized the latch is engaged, or opened, as shown in block 214. Data relating to the card, or input device that engaged the latch is stored. This data may include for example, the time the latch was engaged, an identifier of the card, or input device, that engaged the latch, the location where the latch was engaged as well as any other data that was gathered from the card, or input device.

Block 218 shows that additional data may be input into a database. This additional information may be for example, information pertaining to a bag or compartment that security personnel desires to take notice. For example, if the contents of a bag are examined and found to have a controlled substance, explosive, toxic materials or other potentially illegal or harmful material, the security personnel can input an alert code that will be associated with that particular bag or compartment. This data is stored in a database as shown in block 220. Block 222 shows that the data can be output, for example, as a manifest of the number of times the bag or compartment was opened, the locations the bag or compartment was opened and/or if there were any alert codes indicated at any time during transport of the bag or compartment. The output can be either as a printed report or an electronic document.

Block 224 shows that the tracing data (data obtained by opening and closing the bag or compartment) as well as any additional data that is input by persons examining the bag or compartment, (such as notices of contraband) may be transmitted to a remote database, which can compile and manipulate the received data to generate profiles and trends that can be used to identify potential security concerns.

Block 226 is a decision block that determines whether there are additional bags or compartments to be examined. If “YES” line 230 leads to block 232, which shows that historical, or previously obtained data can be retrieved. Line 234 then leads to block 210 that determines whether an access card is authorized to open the bag or compartment, and the process proceeds as described above. If there are no more bags or compartments to be scanned, line 228 leads to end block 236.

A plurality of locks, as described herein, may also be electronically coupled to one another such that each lock can be independently traced as well as collectively traced. This facilitates a traveler keeping track of multiple pieces of luggage. When more than one lock is associated with an individual, a manifest may be generated that lists the activity of each lock. The locks may also be traced using the GPS system described above and shown in FIG. 2.

The present invention has been described by examples; however, it is also an embodiment of the present invention that the lock, as described, may include means for inputting programmed data to a latch. This could be for example, an input port on the lock, or an input port operatively coupled to the lock or a detachable input module that can be plugged into the lock.

The lock, as described herein, may also include means for detecting engagement of the latch. This may include, for example, an RFID (radio frequency identification) tag, an IR (infrared) tag, a magnetic code reader, a bar code scanner, an optical character scanner or other device or module or facility that detects particular data on a medium.

The lock, as described herein, may also include means for storing data relating to the programmed data capable of engaging the latch. This may be, for example, an electronic storage medium, or memory, such as RAM (Random Access Memory) ROM (Read Only Memory) PROM (Programmable ROM) or other memory.

The lock, as described herein, may also include means for identifying the lock using a coded data representation. This may be for example, a bar code, or an encrypted representation of data, such as a person's name, address or other identifying data that can be affixed to the lock or compartment and then scanned or decoded or decrypted to enable correlation between the identification data on the lock and a user or owner of the lock.

The lock, as described herein, may also include means for outputting data relating to engagement of the latch. This may be, for example, a printer connection to be coupled to a printing device or a port, such as a USB port or an RJ11 jack, or a wireless port, or an IR port or a card reader to download data from the lock to the storage medium, such as a magnetic card or smart card or other storage medium.

While the present invention has been described in terms of a lock, it is an embodiment of the invention that the lock as described herein may be fabricated as part of the luggage, baggage, rail car, trailer or other compartment or alternatively, may be attachable and detachable to the luggage, baggage, rail car, trailer or other compartment. In either embodiment, the lock can be registered to a user so that if dangerous or prohibited materials are found within the compartment, the owner, or user, of the lock can be identified.

While the present invention has used terms such as “coupled to”, “operatively connected”, “operatively interconnected”, it is to be understood that those terms mean that the components are not necessarily assembled in a specific configuration or that other components may or may not be between, or disposed within the described components.

While the present invention has been described with reference to specific embodiments, and applicant has attempted to describe foreseeable equivalents, there may exist other equivalents that are unforeseeable, or insubstantial differences that remain as equivalents.

What is claimed is:

1. An apparatus comprising:
a latch mechanism adapted to move between an engaged position and a disengaged position;
an input facility adapted to receive programmed data, the programmed data capable of engaging the latch mechanism;
a detection facility, coupled to the latch mechanism, the detection facility adapted to detect engagement of the latch mechanism;
a memory facility adapted to store data relating to the programmed data that engaged the latch mechanism;
an identifier mounted in proximity to the latch mechanism that identifies the apparatus; and
an output facility that outputs data representative of latch mechanism activity.

2. The apparatus as claimed in claim 1, further comprising:
a scanning mechanism adapted to obtain data from the identifier and transmit the data to a storage facility.

3. The apparatus as claimed in claim 2, further comprising:
an input device, coupled to the scanning mechanism, the input device adapted to enable input of additional data relating to contents of a compartment into a storage facility.

4. The apparatus as claimed in claim 3, wherein the storage facility is adapted to store data relating to a particular latch mechanism and a particular user.

5. The apparatus as claimed in claim 4, further comprising:
a remote memory adapted to interface with the storage facility.

6. The apparatus as claimed in claim 1, wherein the detection facility includes a radio frequency identification (RFID) element.

7. The apparatus as claimed in claim 1, wherein the detection facility includes an infrared element.

8. The apparatus as claimed in claim 1, wherein the programmed data is stored on a storage medium.

9. The apparatus as claimed in claim 8, wherein the storage medium has authorization data stored thereon.

10. The apparatus as claimed in claim 1, wherein the output facility includes a universal serial bus (USB) port.

11. The apparatus as claimed in claim 1, wherein the identifier includes coded data.

12. The apparatus as claimed in claim 1, wherein the identifier includes a bar code.

13. The apparatus as claimed in claim 1, further comprising:
a mechanism adapted to engage the latch mechanism and store data relating to the latch mechanism.

14. The apparatus as claimed in claim 13, wherein the mechanism is adapted to transmit data from the mechanism to a storage facility.

15. The apparatus as claimed in claim 13, wherein the mechanism includes biometric information stored thereon.

16. The apparatus as claimed in claim 1, further comprising a global positioning satellite (GPS) module in communication with a storage facility, wherein the GPS module provides tracking data for the apparatus.

17. The apparatus as claimed in claim 1, further comprising:
a storage facility, coupled to the output facility, the storage facility adapted to store data that represents a time of latch mechanism engagement, a location of latch mechanism engagement and a user code.

18. A method for enabling engagement of a lock comprising:
providing programmed data to a latch;
detecting engagement of the latch;
storing data relating to the programmed data capable of engaging the latch;
identifying the lock using a coded data representation; and
outputting data relating to engagement of the latch.

19. The method as claimed in claim 18, further comprising:
obtaining data relating to the programmed data and the coded data representation.

20. The method as claimed in claim 18, further comprising:
inputting additional data relating to the lock into a database.

21. The method as claimed in claim 18, further comprising:
scanning the coded data representation; and
storing the scanned data in a database.

22. The method as claimed in claim 18, further comprising:
correlating the coded data representation to a particular user.

23. A system comprising:
a lock;
a latch mechanism, mounted on the lock;
an input facility adapted to receive programmed data, the programmed data capable of engaging the latch mechanism;
a detection facility, coupled to the latch mechanism, the detection facility adapted to detect engagement of the latch mechanism;
a memory facility adapted to store data relating to activity of the latch mechanism; and
an output facility that outputs data representative of latch mechanism activity.

24. The system as claimed in claim 23, further comprising:
a storage facility, coupled to the output facility, the storage facility adapted to store the data representative of latch mechanism activity.

25. The system as claimed in claim 23, wherein the data representative of latch mechanism activity includes a time of latch engagement, a location of latch engagement and a user code.

26. The system as claimed in claim 23, wherein the memory facility is located within the lock.

27. The system as claimed in claim 23, wherein the memory facility is located outside the lock.

28. The system as claimed in claim 23, further comprising:
an identifier mounted in proximity to the latch mechanism that provides identification data.

29. An apparatus comprising:
a database adapted to store data relating to activity of a lock mechanism; and
an input module, coupled to the database, the input module adapted to input data relating to a particular lock mechanism, wherein the data relating to activity of the lock mechanism includes a time the lock was opened and a location the lock was opened and identification of a key used to open the lock.

30. An apparatus for enabling engagement of a lock comprising:
means for inputting programmed data to a latch;
means for detecting engagement of the latch;
means for storing data relating to the programmed data capable of engaging the latch;
means for identifying the lock using a coded data representation;
and means for outputting data relating to engagement of the latch.

31. The apparatus as claimed in claim 30 further comprising:
means for retrieving the coded data representation; and
means for storing the retrieved coded data representation in a database.

32. A system for tracking a plurality of articles comprising:
one or more locking mechanisms, each locking mechanism affixed to an associated article, and each locking mechanism having a detection facility adapted to detect engagement of the locking mechanism;
one or more engagement devices, each engagement device adapted to engage the locking mechanisms;
a storage facility adapted to store data relating to the engagement of the locking mechanisms; and
an output facility adapted to output data relating to the engagement of the locking mechanisms.
